(19) United States
(12) Patent Application Publication
(10) Pub. No.: US 2013/0154941 A1
(43) Pub. Date: Jun. 20, 2013

(54) Enhanced Tablet Computer

(71) Applicant: George Moser, Redwood City, CA (US)

(72) Inventor: George Moser, Redwood City, CA (US)

(21) Appl. No.: 13/817,440

(22) PCT Filed: Aug. 16, 2011
(86) PCT No.: PCT/US2011/047985

§ 371 Date: Feb. 16, 2013

Related U.S. Application Data
(60) Provisional application No. 61/401,595, filed on Aug. 16, 2010.
(60) Provisional application No. 61/455,581, filed on Oct. 22, 2010.

(51) Int. Cl. G06F 3/041

(52) U.S. Cl. CPC G06F 3/041
USPC 345/168

(57) ABSTRACT

A tablet computer (10) is provided, having an integrated keyboard (14). Such a keyboard (23) may be derived from a transparent or translucent construction and overlay a tablet touch sensitive display (24) while enabling viewing of the display (24) through the keyboard. The keyboard (23) may support positioning for multiple display orientations, such as portrait or landscape.

### TECHNICAL FIELD

The invention is in the area of electronic computers, with primary focus on tablet computers.

### BACKGROUND OF THE INVENTION

Tablet computers have grown in popularity because of their portability and attractive applications (apps) they can run. However, conventional tablet computers still have some major shortcomings remain which are addressed by aspects of this invention.

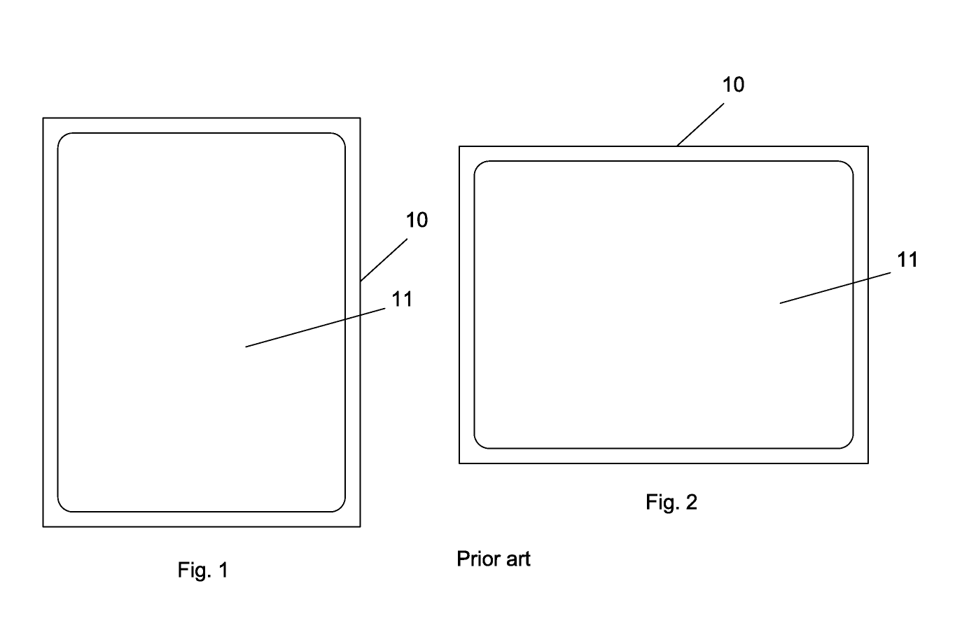

As shown in FIG. 1, a typical tablet computer includes a tablet computer housing 10 and a touchscreen panel 11 which is used for user input. Inside the housing 10 and underneath the touchscreen panel 11 there are the internal components of the computer (not shown in FIG. 1), such as the motherboard, the data storage device, the battery and others. FIG. 1 shows the tablet being held in portrait orientation.

FIG. 2 shows the tablet computer being held in portrait orientation.

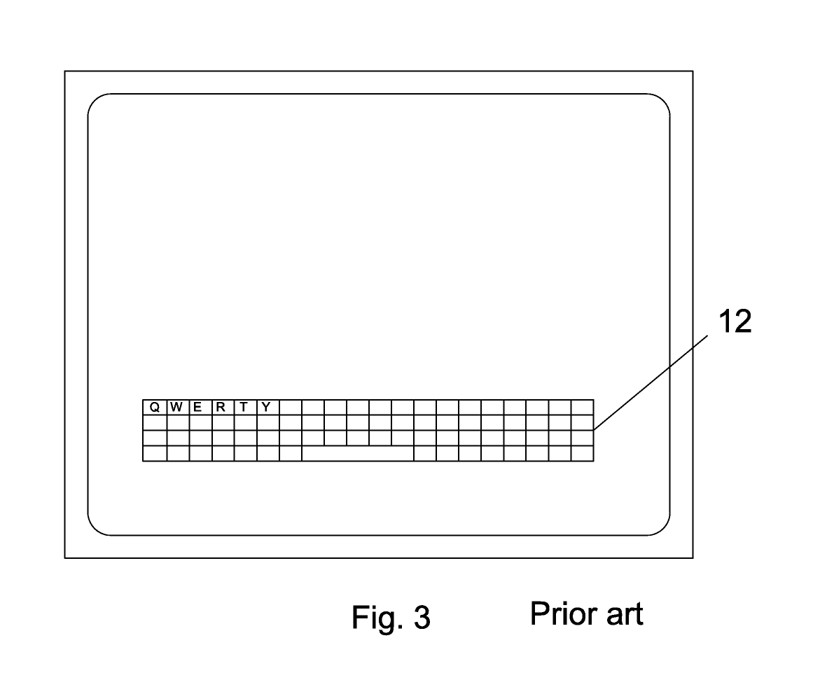

The greatest shortcoming of the tablet computer as shown in FIGS. 1 and 2 is the input. Normally the only way to input information into the computer is via the touchscreen. That is acceptable for simple Yes or No answers, or when it is enough to click on a box. However, sometimes the user needs to enter a substantial amount of information, such as to create a document, write an email, enter information into a form, etc. In that case, the touchscreen can still be used by displaying a keyboard image 12 (a so-called “virtual keyboard”) on the screen, as shown in FIG. 3. The user chooses each character by clicking on the corresponding key on this virtual keyboard. That is painfully slow and very error-prone. The lack of tactile feedback also makes it feel unnatural and unfriendly. As a result, for any serious work the tablet becomes inadequate and the user has to switch to a “real” computer, which relegates the tablet to the category of “toy” to play music, games and very superficial applications. The true potential of the tablet computer cannot be achieved without proper input. This invention corrects that shortcoming by giving the tablet computer real and practical input facilities. This and other aspects of the invention are disclosed and described below.

### DESCRIPTION OF THE INVENTION

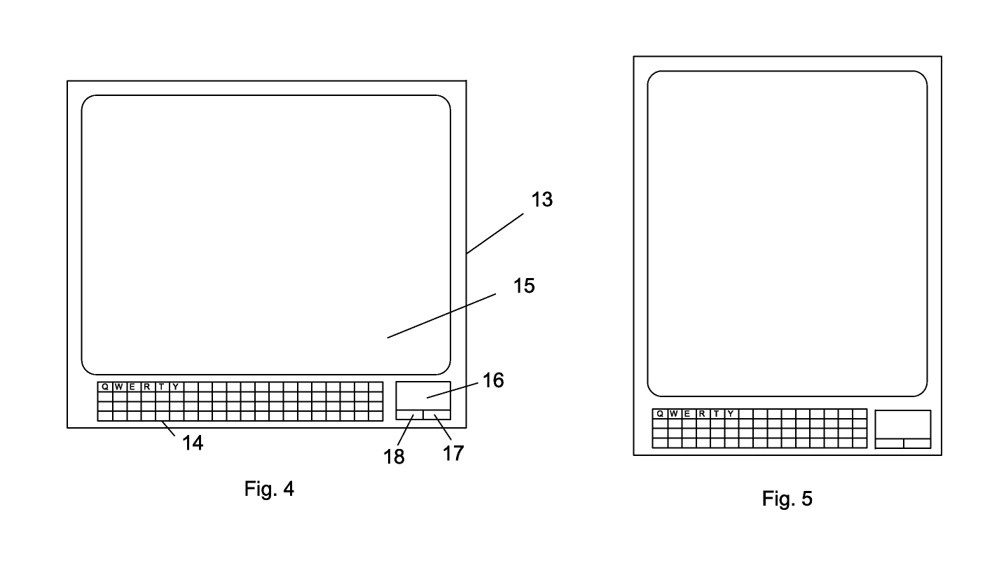

In accordance with one aspect of the invention shown in FIG. 4, a tablet computer 13 is configured with a housing 13, a touchscreen panel 15, a keyboard 14, a touchpad 16 and touch buttons 18 and 17. This solution is workable, but it still has some serious shortcomings: a) it substantially increases the size of the tablet; and b) it works only in landscape mode. FIG. 5 shows a slight variation of FIG. 4 with the keyboard supporting a portrait orientation rather than a landscape orientation. However, FIG. 5 supports only portrait mode. Since the user may need to use the tablet computer sometimes in landscape orientation and sometimes in portrait orientation, it is necessary to provide an input solution that supports both modes.

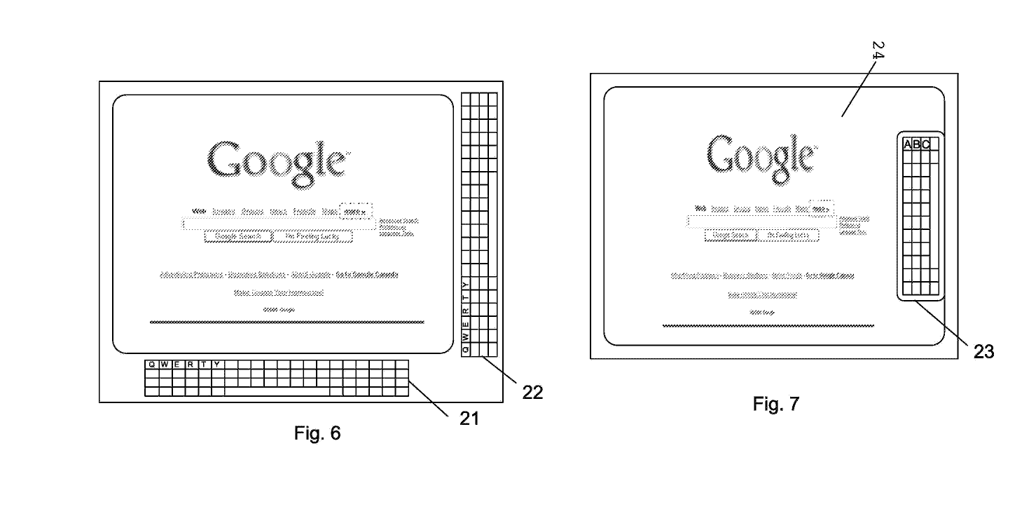

FIG. 6 shows a tablet computer with a landscape keyboard 21 and a portrait keyboard 22. This embodiment does provide support for both modes of operation, but at the same time it substantially increases the size, weight and cost of the tablet computer.

FIG. 7 shows a preferred embodiment of this invention with a single keyboard 23, which can support both portrait and landscape modes. This keyboard is made of a substantially transparent material, so that the key labels (such as A, B, C, etc.) can be displayed on the appropriate spots on the screen 24 and the user can clearly see them through the keys. The keyboard 23 is a mechanical keyboard with the normal features of such keyboards, such as tactile feedback and quick, multi-finger input.

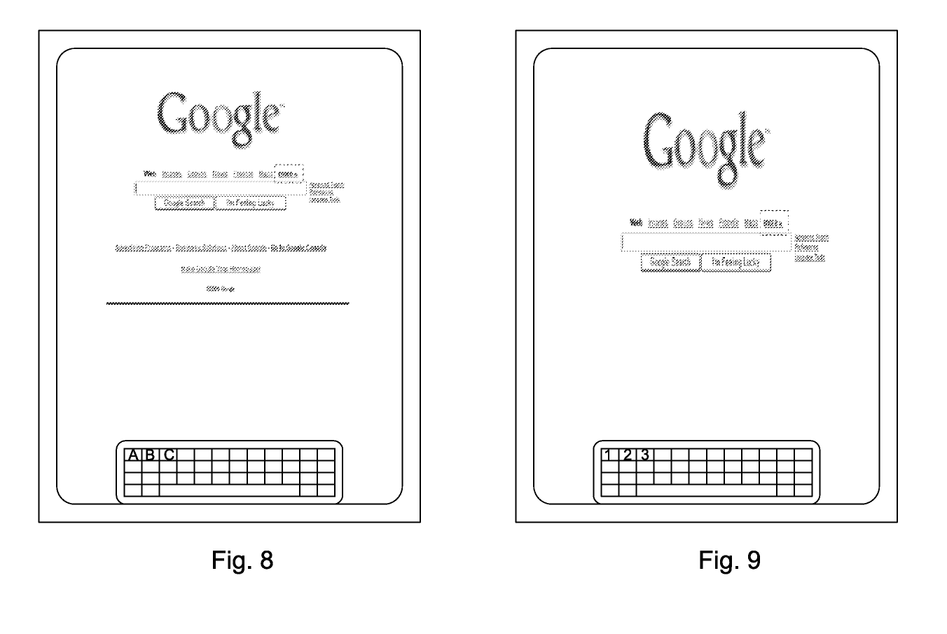

FIG. 8 shows that when the tablet computer of FIG. 7 is rotated to portrait orientation, the contents of the screen is adjusted, including the orientation of the key labels, so that the keyboard remains fully usable. FIG. 8 also shows another major advantage of the variable key labels: it is not necessary to put multiple labels on the keys, as typically done on conventional keyboards, or to have dedicated keys for numbers, punctuation, special symbols, etc. Instead, the user can press a key (probably labeled Num for Numbers, or something similar) and the keyboard can be instantly switched to numeric input, as shown in FIG. 9. The same can be achieved for punctuation, special symbols, foreign keyboards, etc. The keyboard can also be configured by the software application to cooperate with the application, such as defining certain keys as YES, NO, BACK, CONTINUE, GO, CANCEL, EXIT, etc. As a side benefit, this can lead to some level of standardization in application software which can simplify the learning and usage of software applications.

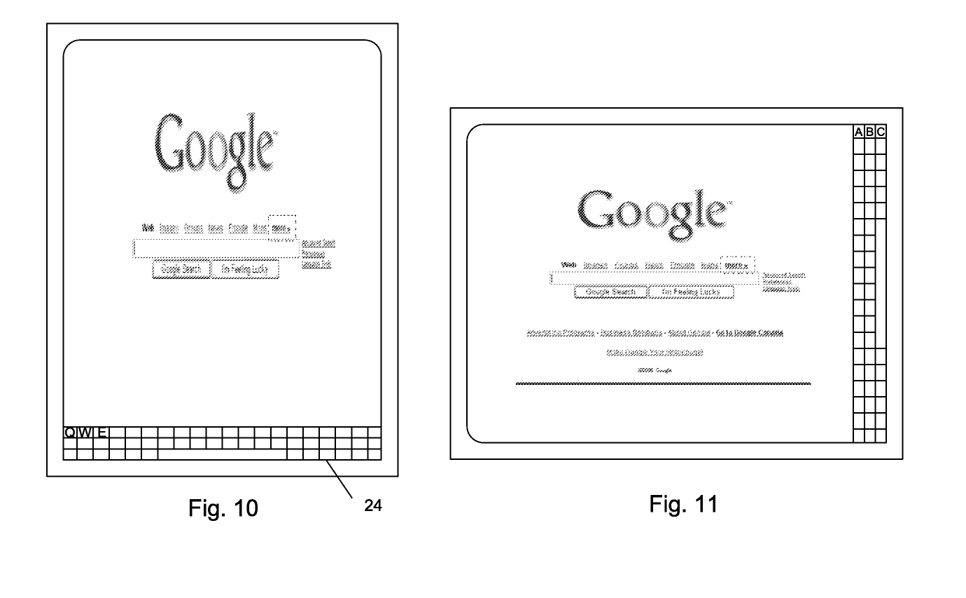

Since there is no need to dedicate keys, the keyboard can be made with significantly fewer keys than in conventional keyboards. Also, since there is no need to squeeze multiple labels on the keys, the key surface can be made smaller. As a result, the keyboard can be made significantly smaller than conventional keyboards. FIG. 10 shows a small and narrow keyboard 24 at the bottom of the screen in portrait mode. FIG. 11 shows the same keyboard 24 in landscape mode.

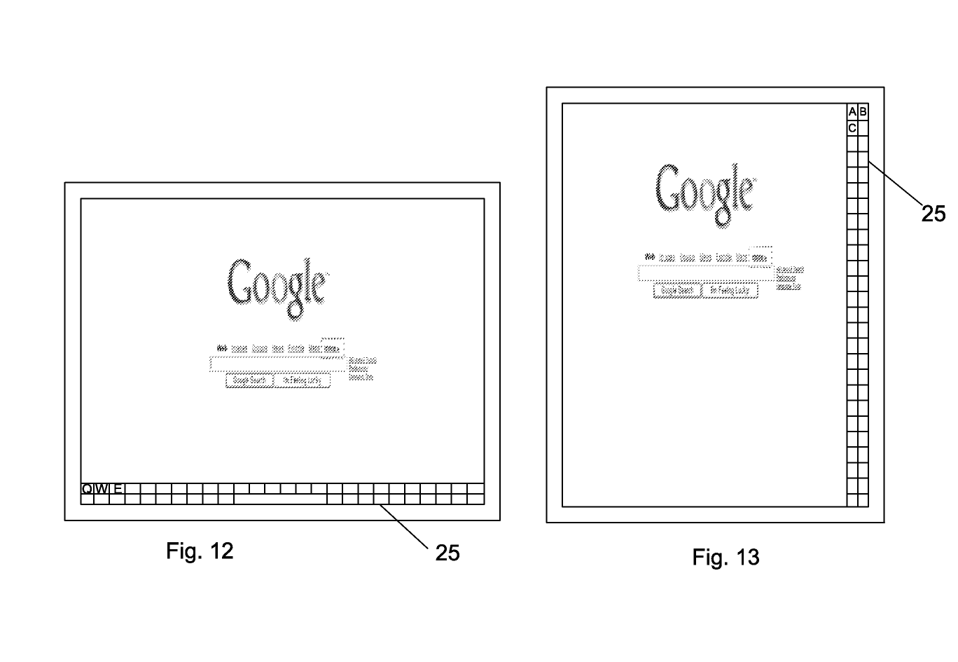

FIG. 12 shows another possible embodiment of the invention: 25 is a narrow keyboard at the bottom of the screen in landscape mode. Because of the length available for the keyboard in this configuration, it can be designed in a very narrow configuration, possibly with just one or two rows of keys. FIG. 13 is the same embodiment with the same keyboard 25 in portrait mode.

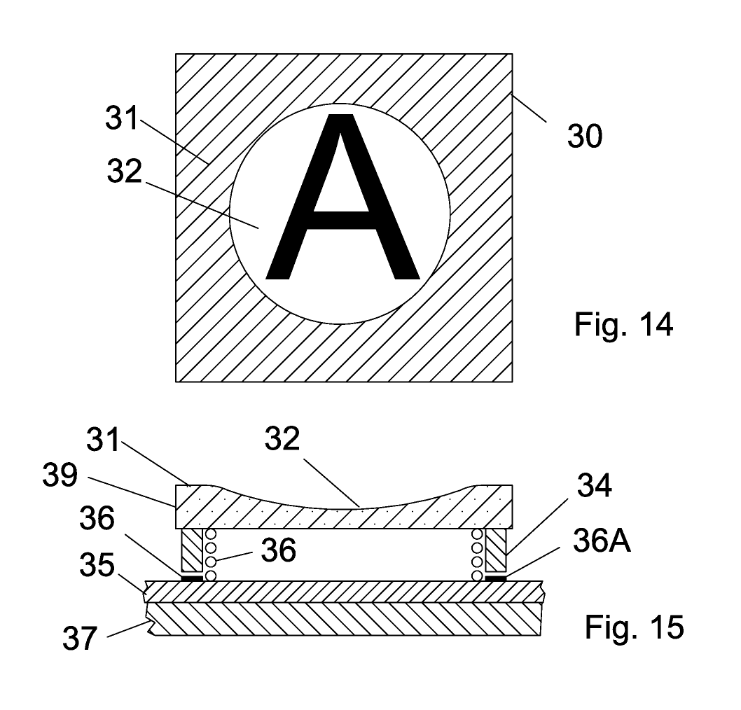

FIGS. 14 through 18 describe how the partly transparent keyboard can be built for the keyboard of the present invention. FIG. 14 is a top view of a key 30, in this case for the letter A. The central area 32 with the letter A in it is transparent. The shaded area 31 is not necessarily transparent, and it generally will not be, because it can be used to hide the mechanical and electrical components of the keyboard. FIG. 15 is a cross-section of the key, illustrating that the letter A is not on the key top 32, but on the display screen 37 under the key. The conductive carrier 34 carries the keycap 39 and it is biased away from the keyboard PCB (printed circuit board) 35 by spring 36. When the key is pressed down by a keystroke, it compresses the spring and the carrier 34 touches the PCB traces 36 and 36A, closing the circuit between them. The PCB microprocessor interprets this closed circuit as the corresponding key having been pressed. This is just one of many possible architectures that can be used to implement this aspect of the invention.

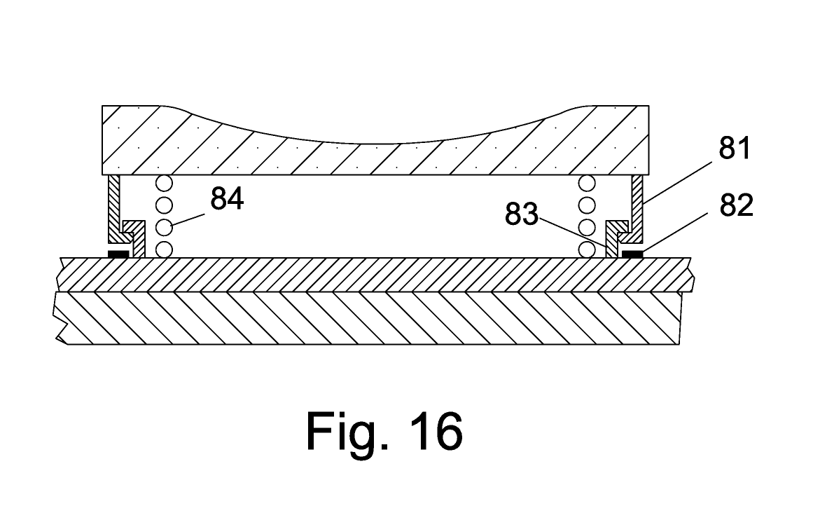

FIG. 16 is a more detailed version of the previous two figures. In particular, this figure shows the guidance structure of the key, which was omitted in FIG. 15 for simplicity of the drawing. The conductive carrier 81 is guided by internal support 83.

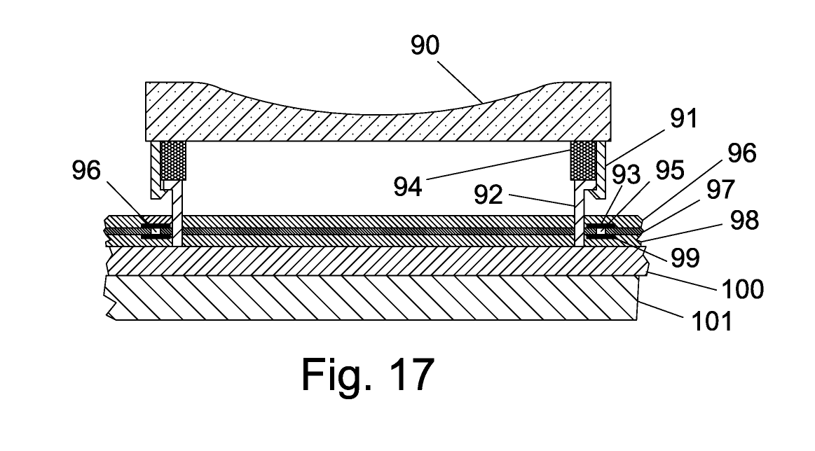

FIG. 17 shows another embodiment of the transparent key structure, which is better suited for high volume mass production. The backplate of the keyboard is the transparent plate 100, which holds most keyboard components. The backplate 100, made of glass or transparent plastic, is attached to the display screen 101. The keycap 90 is attached to the carrier 91, which is guided by the internal support 92 (which is attached to the backplate 100). An elastomeric spring 94 biases the keycap 90 away from the backplate 100. Layers 96 and 98 are separated by insulator layer 97. The insulator layer 97 has multiple holes such as 95 and 96, which are located across from the top conductive pad 93 and the bottom conductive pad 99.

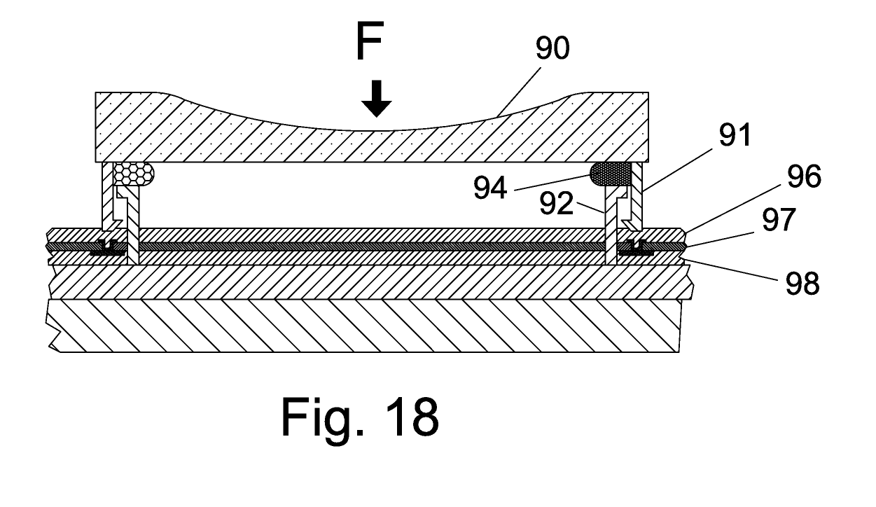

FIG. 18 shows what happens when the keycap 90 is depressed by a force F applied by the user's finger. The keycap 90 descends, compressing spring 94. At some point in its downward travel, the plunger 91 compresses the top layer 96, squeezing the top conductive pad through the hole and therefore establishing contact between the two conductive pads. This contact between the pads is interpreted as the corresponding key having been pressed.

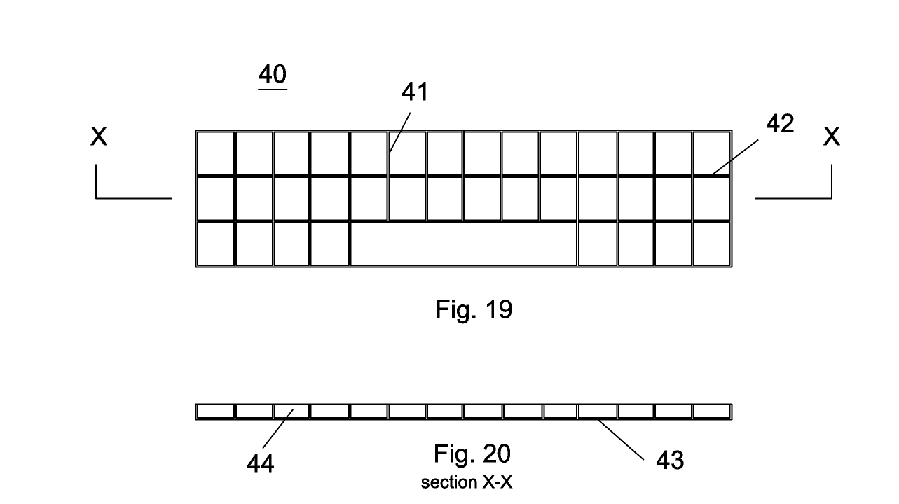

FIG. 19 shows a different embodiment with a different type of keyboard intended to provide tactile feedback to the user without the need for a mechanical keyboard as the ones described in the previous embodiments. There have been numerous attempts to provide tactile feedback to touchscreen displays, but until now they have not been satisfactory. FIG. 19 shows a grid or matrix 40 made of plastic, glass or similar transparent material, with a series of walls in X-direction (such as 42) and a series of walls in Y-direction (such as 41). FIG. 20 is a cross-sectional view of the grid, showing that this grid has a bottom 43, which defines a series of compartments 44, each corresponding to a key.

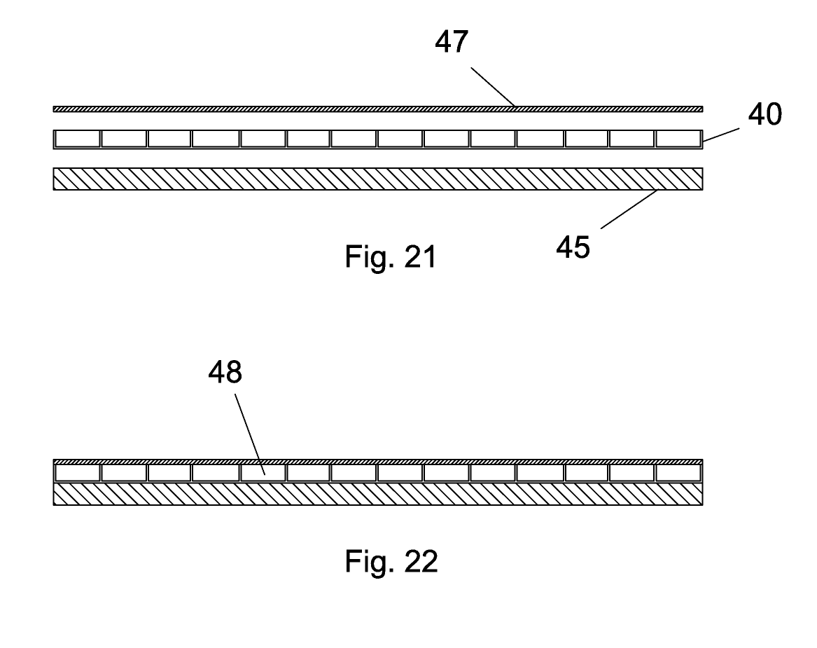

FIG. 21 shows the layers used to assemble the display unit according to this embodiment of the invention. 45 is the LCD panel, 40 is the previously described grid, and 47 is a flexible transparent overlay that is placed on top of the grid.

Therefore the matrix 40 is “sandwiched” between the overlay and the LCD panel. The LCD panel can be a conventional LCD panel as commonly used in laptop computers or alternatively an electronic ink display as used in electronic reader devices such as the kindle. The term “LCD or similar” in this document includes electronic displays.

FIG. 22 shows the assembled display unit. Each one of the compartments 48 may be optionally filed with air or with an elastic medium such as foam.

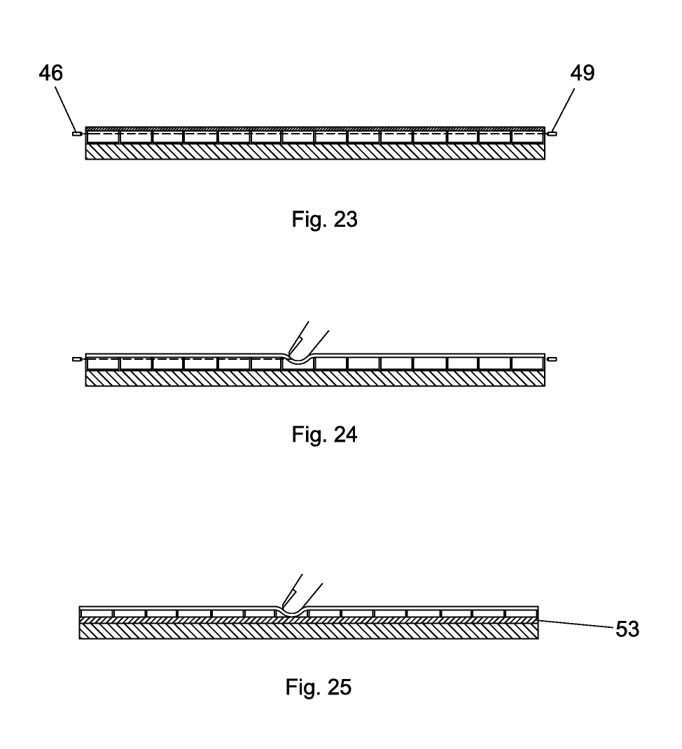

FIG. 23 shows light gun 46 which sends a light ray such as an infrared signal to receptor 49, which detects and reports any interruption of the light reception. That happens when the user touches the screen overlay in FIG. 24. A small but perceivable elastic deformation takes place, providing the sensation of a yielding key and its elastic resistance, thus giving the desired tactile feedback to the user. At the same time, the light ray is temporarily interrupted and the receptor 49 reports the event, which is appropriately interpreted by the touchscreen processor. Since there are light guns and receptors in both X and Y directions, actually two light rays get interrupted, and the processor can assign coordinates X and Y to the point of touch. Of course, instead of infrared or light signals other standard touchscreen technologies can be used in conjunction with the tactile feedback method described herein, including but not limited to resistive touchscreens, capacitive touchscreens,

SAW technology, other sonic, optical and magnetic sonic technologies and other methods. This is shown in FIG. 25, which does not have a light emitter and a light receptor, but instead a touchscreen layer 53 located between the display and the matrix (in this case the matrix needs to have an open bottom to facilitate contact between the depressed overlay and the touchscreen).

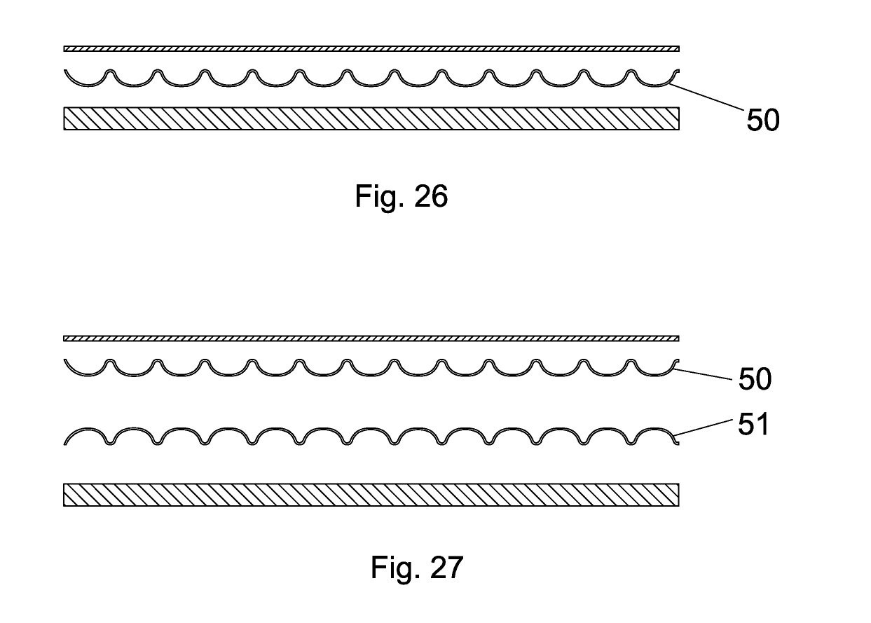

FIG. 26 shows that the grid 50 can be shaped in a rounded, wavy pattern (as opposed to a straight angle matrix) which makes it less visible through the overlay. The curvature of the grid can also be used as a set of lenses to make it easier to read the key labels.

FIG. 27 shows that an approximately oppositely curved grid 51 can be used to correct distortions and optical aberrations caused by the grid.

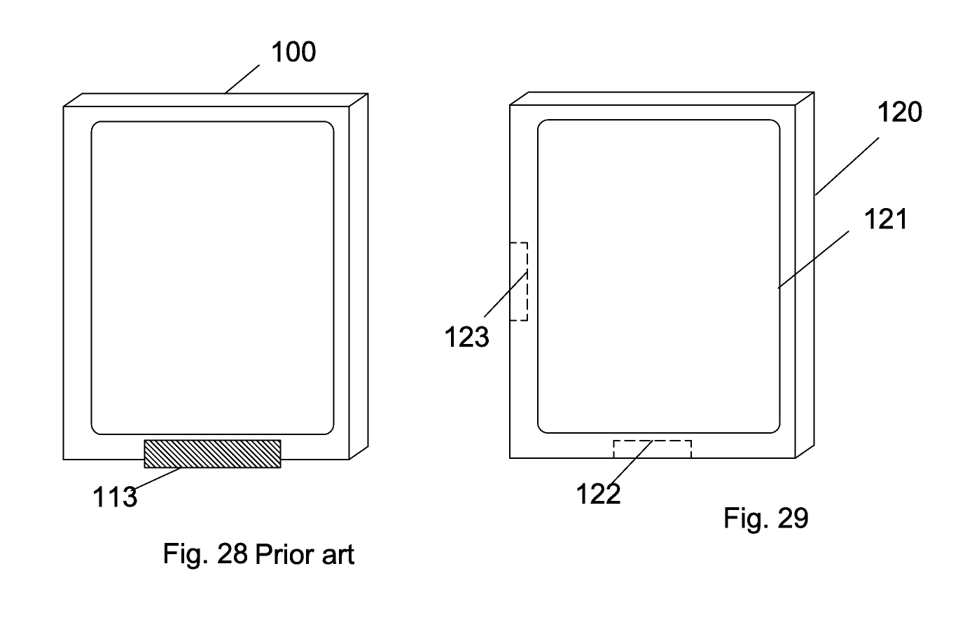

FIG. 28 is used to illustrate another problem area of tablet computers: tablets periodically need to connect with a dock in order to recharge and also to interface with other devices. Tablets are typically equipped with a docking connector that is used to plug the tablet into the dock 113. The dock connector forces the tablet to be held in portrait orientation, which may not be the orientation needed or desired by the user. Another shortcoming is that the tilting angle of the tablet computer when inserted into the dock is constant, resulting in a viewing angle that is not adequate for many users.

FIG. 29 shows a tablet computer 120 is configured with dual docking connectors 122 and 123. This gives the user the option to mount the tablet computer in the dock in either a landscape or a portrait orientation, depending on the particular application and preferences of the user. The internal configuration of the tablet computer (not shown here) requires appropriate wiring between the motherboard, the internal devices and the two dock connectors 122 and 123. An orientation detection system such as gravity sensors or accelerometers may be required too to switch the display from landscape to portrait mode or vice versa. A sensing pin can also be used to detect orientation when the tablet is plugged into the dock. An internal switchboard may be needed too to deactivate circuits and branches inside the tablet computer that are not used in one mode or the other, which also serves the purpose of not having live energized connectors on the outside of the computer when they are not in use.

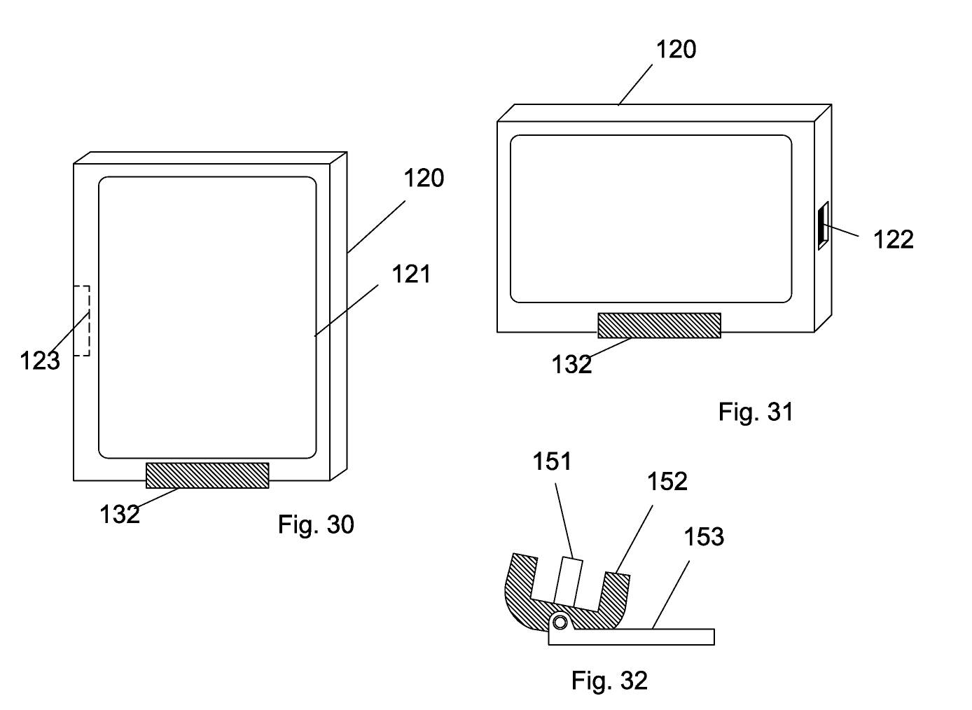

FIG. 30 shows a front view of tablet computer 120 inserted into dock 132 in portrait mode.

FIG. 31 shows the same tablet computer 120 now inserted into the same dock 132 in landscape mode. This is a new capability provided by this invention.

FIG. 32 shows an improved dock which comprises a dock base 153 and a pivotable dock body 152 with a docking connector 151. This improved dock allows the user to adjust the viewing angle according to his or her needs. That is a new capability provided by this invention.

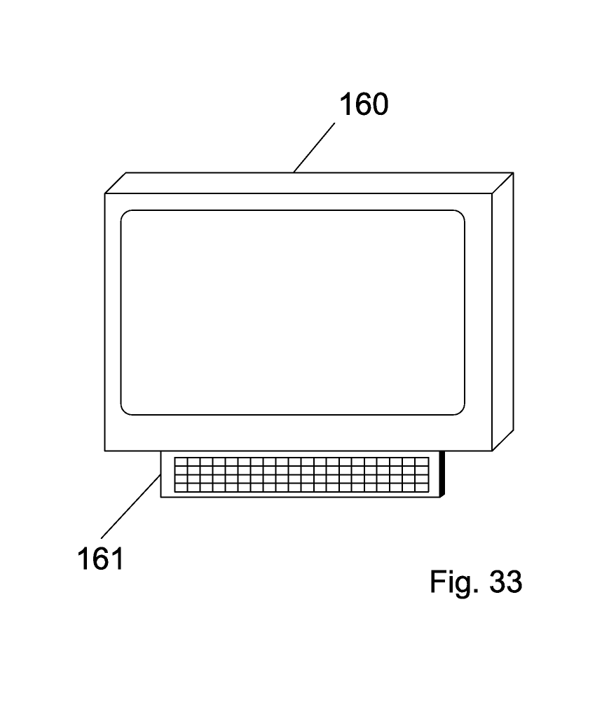

FIG. 33 shows another improvement to a tablet computer. The tablet computer 160 is equipped with an extendable and retractable keyboard 161, which adds convenience and portability to the tablet computer, because the touchscreen is generally nor adequate for typing or entry of large amounts of data. For small amounts of data entry the touchscreen is sufficient, but there is a need for a faster and more reliable data entry method for tablet computers, and this keyboard, which can be of a miniature size to save space and weight, can provide that capability.

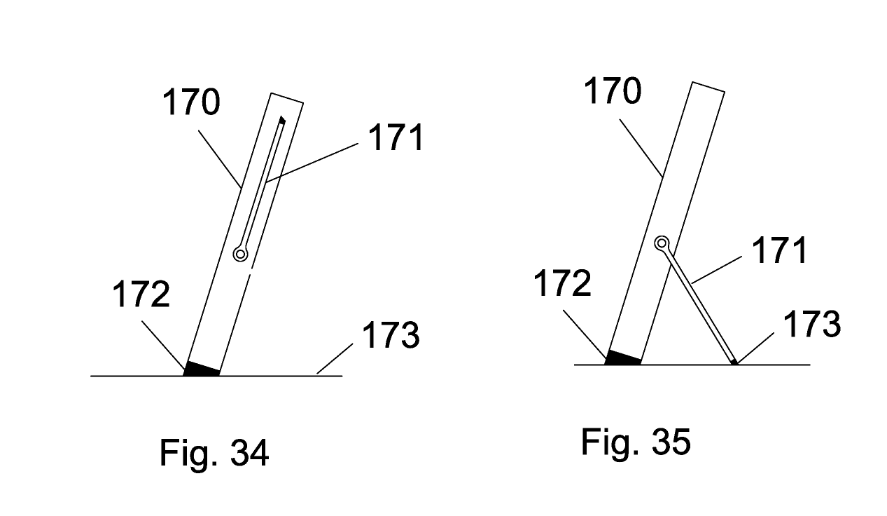

FIG. 34 shows another improvement for tablet computers, which currently lack a support system of their own to hold them in a position convenient to the user. A dock can provide that capability, but most users don't travel with a dock. Therefore, according to this invention, the tablet computer 170 has deployable supports 171 that can support the tablet computer in a desired position. The edge of the tablet computer can be equipped with an anti-slip surface 172 made of rubber or similar material, while the support beam 171 can be equipped with a rubber tip 173 to prevent sliding. In addition an adjustable detent mechanism (not shown) can be provided to prevent unintended changes in the angle. FIG. 34 shows the support structure before deployment. FIG. 35 shows the support structure after deployment

1-33. (canceled)

34. A tablet computer comprising:
a tablet computer housing;
a first display panel set within said housing;
a keyboard overlying said first display panel, said keyboard comprising a plurality of key mechanisms, each of said key mechanisms comprising: a key cap, said key cap including a first portion that is substantially transparent, and a second portion that is not substantially transparent; and a compressible spring mechanism positioned beneath said second portion of said key cap, whereby said key cap provides visibility of a portion of said first display panel beneath said key cap first portion while obscuring the visibility of said compressible spring mechanism beneath said second portion.

35. The tablet computer of claim 34, in which said compressible spring mechanism comprises a coil spring.

36. The tablet computer of claim 34, in which said compressible spring mechanism comprises an elastomeric spring.

37. The tablet computer of claim 34, in which said key mechanisms further comprise:
a conductive carrier extending downwards from said key cap;
a plurality of electrically conductive contacts on a carrier layer, at least part of which is substantially transparent, said contacts be positioned beneath said key cap conductive carrier;
whereby said spring mechanism normally biases said key cap and key cap conductive carrier away from the carrier layer such that a gap is formed between the key cap conductive carrier and the carrier layer contacts, and whereby said spring mechanism can be elastically deformed in response to the application of pressure to the key cap such that the key cap moves downwards towards said first display panel and the key cap conductive carrier makes contact with the carrier layer contacts.

38. The tablet computer of claim 34, in which a top surface of said keyboard key caps are substantially coplanar with a top surface of said tablet computer housing.

39. The tablet computer of claim 34, in which:
said first display panel further comprises a touch sensitive layer on a top surface of said first display panel;
each said key mechanism further comprises a conductive element extending downwards from said key cap towards said touch sensitive layer; and
said spring mechanism normally biases said key cap and key conductive element away from said touch sensitive layer such that a gap is formed between the key conductive element and the touch sensitive layer, and whereby the spring mechanism can be elastically deformed in response to downward pressure on the key cap such that the key conductive element moves downwards to contact the touch sensitive layer;
whereby said tablet computer can identify which of a plurality of key mechanisms is depressed via detection of the position of key conductive element contact with said touch sensitive layer.

40. A tablet computer comprising:
a tablet computer housing;
a flexible overlay substantially coplanar with a top surface of said tablet computer housing;
a matrix structure positioned beneath the flexible overlay, the matrix structure defining a plurality of cavities and being comprised of a substantially transparent material;
a display panel underlying the matrix structure, the display panel operable to display a key symbol beneath each of the plurality of cavities;
a plurality of optical emitters oriented to transmit light beneath and parallel to the flexible overlay;
a plurality of optical detectors beneath the flexible overlay, each of the optical detectors positioned to receive light emitted by one or more of the optical emitters;
whereby downward deformation of the flexible overlay can act to interrupt the transmission of light between one or more of the optical emitters and one or more of the optical detectors.

41. The tablet computer of claim 40, in which the matrix structure comprises a grid defined by a plurality of perpendicular walls.

42. The tablet computer of claim 40, in which the matrix structure comprises a continuous layer, and in which each of said matrix cavities comprises a rounded depression within the matrix structure continuous layer.

43. The tablet computer of claim 40, in which the matrix structure comprises a first continuous layer positioned beneath the overlay, and a second continuous layer positioned beneath the first continuous layer, and in which each of said matrix cavities comprises a rounded depression within the first continuous layer and a rounded protrusion within the second continuous layer, each rounded depression being symmetric with each rounded protrusion across a plane between the first continuous layer and the second continuous layer.
